(19) United States
(12) Patent Application Publication
(10) Pub. No.: US 2026/0237296 A1
(43) Pub. Date: Aug. 13, 2026

(54) DATA COMPLEMENTATION SYSTEM

(71) Applicant: NTT DOCOMO, INC., Tokyo (JP)

(72) Inventors: Hiroto AKATSUKA, Tokyo (JP); Masayuki TERADA, Tokyo (JP)

(73) Assignee: NTT DOCOMO, INC., Tokyo (JP)

(21) Appl. No.: 19/153,363

(22) PCT Filed: Dec. 25, 2023
(86) PCT No.: PCT/JP2023/046477

§ 371 Date: Aug. 4, 2025

(30) Foreign Application Priority Data
Mar. 30, 2023 (JP) 2023-055725

(51) Int. Cl. G08G 1/01; G08G 1/123

(52) U.S. Cl. CPC G08G 1/0125; G08G 1/123

(57) ABSTRACT

A data imputation system includes an imputation target acquisition unit that acquires traffic data that is data related to traffic for each of a plurality of positions on a traffic route and is also an imputation target; a state information acquisition unit that acquires state information indicating a state of the traffic route; and an imputation unit that imputes the traffic data acquired by the imputation target acquisition unit according to the state information acquired by the state information acquisition unit.

### TECHNICAL FIELD

The present invention relates to a data imputation system for imputing traffic data.

### BACKGROUND ART

Patent document 1 illustrates that when there is missing data in the time-series data representing the number of vehicles traveling on a road, the missing data is imputed. It is said that data from another position is used to impute the missing data.

### CITATION LIST

### Patent Literature

[Patent Literature 1] Japanese Unexamined Patent Publication No. 2017-27515

### SUMMARY OF INVENTION

### Technical Problem

When imputing traffic-related data such as traffic volume, simply using data from another position as illustrated in Patent Document 1 may not necessarily result in appropriate imputation. For example, it is not appropriate to perform the same imputation regardless of whether an interchange, junction, parking area, service area, or the like exists between the position to be imputed and the position related to the data used for imputation.

One embodiment of the present invention has been made in view of the above, and an object thereof is to provide a data imputation system that can appropriately impute traffic data.

### Solution to Problem

To achieve the above-mentioned object, a data imputation system according to one embodiment of the present invention includes an imputation target acquisition unit that acquires traffic data that is data related to traffic for each of a plurality of positions on a traffic route and is also an imputation target, a state information acquisition unit that acquires state information indicating a state of the traffic route, and an imputation unit that imputes the traffic data acquired by the imputation target acquisition unit according to the state information acquired by the state information acquisition unit.

In the data imputation system according to one embodiment of the present invention, traffic data is imputed according to the state information. Therefore, according to the data imputation system according to one embodiment of the present invention, traffic data can be appropriately imputed according to the state of the traffic route.

### Advantageous Effects of Invention

According to one embodiment of the present invention, traffic data can be appropriately imputed.

### BRIEF DESCRIPTION OF DRAWINGS

FIG. 1 is a diagram illustrating the configuration of a data imputation system according to an embodiment of the present invention.

FIG. 2 is a diagram illustrating an example of traffic data that is an imputation target of the data imputation system and traffic data after imputation.

FIG. 3 is a diagram illustrating an example of traffic data (speed data) before and after imputation, and the required time for a road section calculated using the traffic data.

FIG. 4 is a diagram illustrating another example of traffic data (speed data) before and after imputation, and the required time for a road section calculated using the traffic data.

FIG. 5 is a flowchart illustrating the processing executed by the data imputation system according to an embodiment of the present invention.

FIG. 6 is a diagram illustrating a hardware configuration of the data imputation system according to an embodiment of the present invention.

### DESCRIPTION OF EMBODIMENTS

Hereinafter, a data imputation system according to an embodiment of the present invention will be described in detail with reference to the drawings. The same reference signs will be assigned to the same elements in description of the drawings and duplicate description will be omitted.

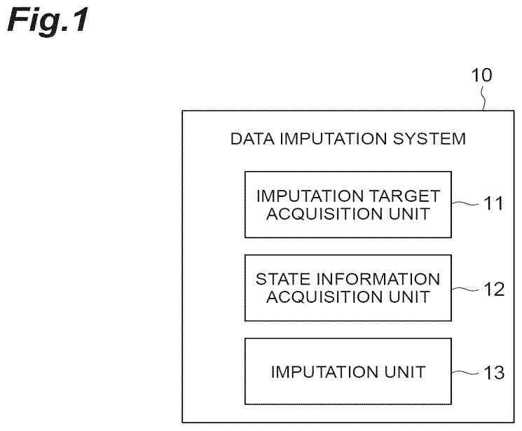

FIG. 1 illustrates a data imputation system 10 according to the present embodiment. The data imputation system 10 is a system (apparatus) that imputes traffic data, which is data related to traffic. The traffic data to be imputed is data related to traffic for each of a plurality of positions on a traffic route. The traffic data may be data for each of a plurality of times. The traffic data in the present embodiment is data on traffic volume or speed for each of a plurality of positions on a traffic route. The traffic volume is, for example, the number of vehicles traveling for each time period (time) and position on the road (traffic route). The speed is the speed (e.g., average speed) of vehicles traveling for each time period (time) and position on the road (traffic route).

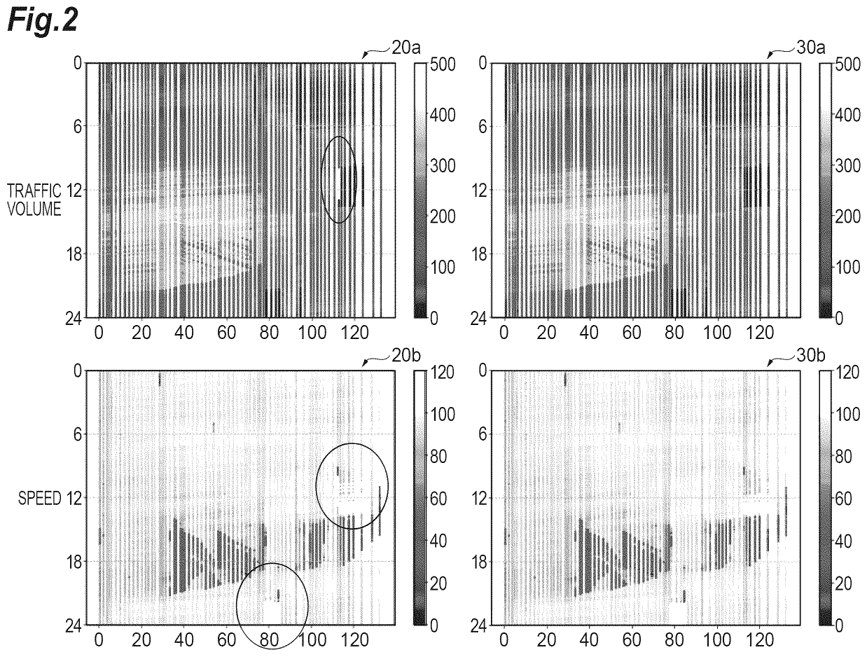

FIG. 2 illustrates an example of traffic data 20 (a collective term for traffic data 20a and 20b) to be imputed, and traffic data 30 (a collective term for traffic data 30a and 30b) after imputation. The traffic data 20a and 20b are traffic volume data. The traffic data 30a and 30b are speed data. In the graph of the traffic data 20 and 30 illustrated in FIG. 2, the horizontal axis indicates the position on the road, and the vertical axis indicates the time. The traffic data 20 and 30 illustrated in FIG. 2 are traffic data for a plurality of positions and times on the road.

The traffic data 20 and 30 are data for each preset position where data (traffic volume, speed) is measured. The position is expressed as X KP, where 0 KP (kilopost) is a preset reference point on the road and X is the distance from that point. The traffic data 20 and 30 are data for each time. For example, traffic data 20 and 30 are data for a preset regular interval (e.g., every 5 minutes). Each value of traffic data 20 is the value of traffic volume for 5 minutes. Each value of traffic data 30 is the value of speed (average speed) for 5 minutes. The traffic data 20 and 30 illustrated in FIG. 2 are a heat map representation of one day data for each position.

The traffic data 30 after the imputation may be used, for example, in a congestion prediction technique using artificial intelligence (AI). It is considered that the number of individuals going to a resort or the like affects the traffic conditions, such as the occurrence and scale of congestion on the way home. Therefore, it is conceivable to predict the traffic conditions from the real-time population (demographic information) of each area. For example, the traffic conditions during the period when people return home are predicted by applying the population of the day to a traffic condition prediction model that learns and patterns the relationship between the population and the traffic conditions. The traffic condition prediction model may include, for example, a traffic demand prediction model that predicts the traffic demand of the day for each position and time from the population distribution of the day, and a required time prediction model that predicts the required time for each section of the road for each position and time from the traffic demand of the day. The traffic data 30 after the imputation may be used as the ground truth data to be used in machine learning for generating the traffic condition prediction model.

The data is measured, for example, by a traffic counter. The traffic counter obtains data by a sensor that is physically installed on the road. Therefore, data may be missing due to malfunction or failure of the apparatus. There are various scales of missing, from large to small, including the entirely missing of data at a certain KP position, the missing of data at all KP positions in a certain time period, and other hole-like data missing. In addition, abnormal data exists, such as traffic volume being 0 and speed being 0, even if the data exists. For example, the elliptical part of the traffic data 20a and 20b to be imputed in FIG. 2 is the missing part. The value of the missing part is, for example, NaN (Not a Number).

The data imputation system 10 imputes, for example, the missing part of the traffic data 20a and 20b where missing has occurred. For example, as described above, a suitable traffic condition prediction model can be generated by performing machine learning for generating a traffic condition prediction model using the traffic data 30 without any missing data after imputation. In addition, the data imputation system 10 may impute parts of the traffic data other than the missing parts. An example of imputing parts other than the missing parts (correction of traffic data) will be described later.

The traffic data to be imputed by the data imputation system 10 may be generated by an apparatus other than a traffic counter, so long as it is data related to traffic for each of a plurality of positions on a traffic route. The reason for the missing data may be other than the above-mentioned imperfections in the data measurement. The format of the traffic data 20a and 20b and the parts to be imputed in the traffic data 20a and 20b are not limited to those described here. The traffic data 30 after imputation may be used for purposes other than those described above.

The data imputation system 10 is constituted by a computer such as a personal computer (PC) or a server apparatus. The data imputation system 10 may be constituted by a plurality of computers. The data imputation system 10 may be capable of transmitting and receiving information to and from other apparatuses via a network in order to obtain information necessary for implementing functions.

Next, the functions of the data imputation system 10 according to the present embodiment will be described. As illustrated in FIG. 1, the data imputation system 10 includes an imputation target acquisition unit 11, a state information acquisition unit 12, and an imputation unit 13.

The imputation target acquisition unit 11 is a functional unit that acquires traffic data that is traffic-related data arranged along a traffic route and is an imputation target. The imputation target acquisition unit 11 may also acquire traffic data arranged in the time direction. The imputation target acquisition unit 11 may acquire traffic data that is traffic volume or speed data for each position on a traffic route.

The imputation target acquisition unit 11 acquires the above-mentioned traffic data to be imputed, for example, by accepting input from a user, or by receiving or reading from another system. The imputation target acquisition unit 11 may acquire the traffic data to be imputed by other methods. The imputation target acquisition unit 11 outputs the acquired traffic data to be imputed to the imputation unit 13.

The state information acquisition unit 12 is a functional unit that acquires state information indicating the state of a traffic route. The state information acquisition unit 12 may acquire information indicating a position of a facility existing on a traffic route as state information.

The state information is, for example, information indicating a position of a facility existing on a road that is a traffic route. The facility may affect traffic data. For example, the facility may be an interchange, a junction, a parking area, a service area, or the like. The traffic volume or speed may vary greatly between positions on either side of the facility. If traffic data is imputed without considering the presence of the facility, the corrected traffic data may be inappropriate and different from the actual traffic volume or speed. In the present embodiment, appropriate corrected traffic data is obtained by imputing the data taking into account the presence of the facility.

The information indicating the position of the facility corresponds to the position on the traffic route related to the traffic data. For example, if the position related to the traffic data is expressed by the distance from a reference point in KP units or the like as described above, the information indicating the position of the facility is the position of the facility expressed by the distance from the same reference point. Furthermore, the information indicating the position of the facility on a traffic route as state information may be information other than that described above. Furthermore, the state information may be information other than information indicating the position of a facility, so long as it is information indicating the state of a traffic route that may affect the traffic data.

The state information acquisition unit 12 acquires state information, for example, by accepting input from a user, or by receiving or reading from another system. The state information acquisition unit 12 may acquire state information by other methods. The state information acquisition unit 12 outputs the acquired state information to the imputation unit 13.

The imputation unit 13 is a functional unit that imputes the traffic data acquired by the imputation target acquisition unit 11 according to the state information acquired by the state information acquisition unit 12. The imputation unit 13 may determine, according to the state information, which direction data of the traffic route, based on the position of the imputation target in the traffic data, will be used for imputation. The imputation unit 13 may determine, according to the state information, whether to perform imputation of the traffic data in the traffic route direction or in the time direction.

The imputation unit 13 imputes the target traffic data, for example, as follows. The imputation unit 13 receives the traffic data to be imputed from the imputation target acquisition unit 11. The imputation unit 13 receives the state information from the state information acquisition unit 12. The imputation unit 13 imputes the traffic data for each type and for a preset fixed period, that is, for each preset unit of traffic data. For example, the imputation unit 13 imputes each of the traffic volume data and speed data on a daily basis. The imputation of individual pieces of traffic data (imputation of traffic volume data and imputation of speed data) may be performed in the same manner.

For small-scale missing in traffic data, it is considered that imputation using values from preceding or succeeding time or position will not result in imputed values that deviate significantly from the actual traffic volume or speed. Therefore, the imputation unit 13 imputes small-scale missing data. The type of small-scale missing is set in advance. For example, if missing data occurs continuously for 30 minutes or more and across 3 KP or more, it is not considered to be a small-scale missing, and the imputation unit 13 does not perform imputation. The range of small-scale missing may be any range other than that described above. The imputation unit 13 also performs imputation taking into account the position of the facility indicated by the state information as follows.

The imputation unit 13 adds missing (NaN) data to parts of the input traffic data that satisfy preset conditions. For example, if the traffic data does not include data for all times for a position where traffic data should be acquired (position where a traffic counter sensor is installed), all values for the respective times at that position are set to NaN, indicating missing data. If the traffic data does not include data for all positions for a time where traffic data should be acquired, all values for the respective positions at that time are set to NaN, indicating missing data. This is because if there is no data for a specific position throughout the day, or if there is no data for all positions for a specific time, the data will not be treated as missing in subsequent processing.

If both the traffic volume and speed values are 0 at the same position and time in the traffic data, the imputation unit 13 sets the values of 0 to missing values (NaN). This is because such data is considered to be abnormal data, as described above. It is not necessary to add or change missing (NaN) data.

Then, the imputation unit 13 detects parts (positions and times) in the traffic data where NaN continues for 30 minutes or more at the same position, and sets a flag for those parts as missing continuously for 30 minutes or more. Then, the imputation unit 13 detects parts (positions and times) in the traffic data where NaN continues for 3 KP or more at the same time, and sets a flag for those parts as missing continuously for 3 KP or more. Then, the imputation unit 13 detects parts (positions) in the traffic data where NaN occurs at positions adjacent to the facilities indicated by the state information, and sets a facility adjacent flag for those parts. The position adjacent to the position of a facility refers to, for example, a position related to the traffic data on a road that is closest to the facility position in each direction on both sides of the road. Alternatively, it may be a position within a certain range from the facility position in each direction on both sides of the road. The position adjacent to the facility position may be an adjacent position other than that described above.

Then, the imputation unit 13 imputes the missing (NaN) parts in the traffic data by using values at another time at the same position. In other words, the imputation unit 13 imputes the missing parts in the traffic data in the direction of time (time direction). The imputation is performed by a preset method, for example, linear interpolation using values at parts before and after the part to be imputed in the time direction. The imputation may be performed by any method including existing methods other than linear interpolation. Note that if the value at another time required for imputation in the time direction is not available, the imputation unit 13 does not perform imputation in the time direction. Then, the imputation unit 13 changes the values of the imputed parts where a flag indicating missing continuously for 30 minutes or more is set, to missing values (NaN) again.

Then, the imputation unit 13 imputes the missing (NaN) parts in the traffic data after the above-mentioned imputation by using values at another position at the same time. In other words, the imputation unit 13 imputes missing parts in the traffic data in the direction of the road (position direction). Imputation is performed by a preset method, for example, linear interpolation using values of parts before and after the part to be imputed in the road direction. The imputation may be performed by any method including existing methods other than linear interpolation. Note that if the value at another position required for imputation in the road direction is not available, the imputation unit 13 does not perform imputation in the road direction. Next, the imputation unit 13 changes the values of the imputed parts where a facility adjacent flag is set, to missing values (NaN) again. The imputation unit 13 may also change the values of the imputed parts where a flag indicating missing continuously for 3 KP or more is set, to missing values (NaN) again.

The imputation unit 13 imputes a missing (NaN) part where the facility adjacent flag is set, using the value of another position that is closest to the position related to the part, located in the road direction opposite to the adjacent facility as seen from the position related to the part at the same time. The imputation is performed by a preset method, for example, by directly copying the value of the other position. In this case, since only the value of another position in one direction as seen from the position related to the part to be imputed can be used for imputation, the imputation may be performed by an imputation method other than the imputation method when performing imputation simply in the time direction or road direction as described above. Note that if the value at the other position required for the above-mentioned imputation is not available, the imputation unit 13 does not perform the above-mentioned imputation.

The imputation unit 13 changes the values of the imputed parts, where a flag indicating missing continuously for 30 minutes or more and a flag indicating missing continuously for 3 KP or more are set, to missing values (NaN) again. The imputation unit 13 regards the traffic data for which these processes have been completed as the imputed traffic data.

In the above-mentioned imputation, the missing (NaN) parts where the facility adjacent flag is set are imputed, using the value of another position located in the opposite direction from the facility. However, the parts where the facility adjacent flag is set may not be imputed and may be left missing in the imputed traffic data. For example, after performing imputation in the time direction as described above followed by the imputation in the road direction, the imputation unit 13 may change the values of the imputed parts where the flag indicating missing continuously for 30 minutes or more is set and the flag indicating missing continuously for 3 KP or more or the facility adjacent flag is set, to missing values (NaN) again, and use them as the imputed traffic data.

Furthermore, in the above-mentioned imputation, imputation is performed in the time direction first and then, imputation is performed in the road direction. However, the imputation unit 13 may perform imputation in the road direction first. In this case, for parts where the facility adjacent flag is set, the imputation unit 13 may perform imputation in the time direction without performing imputation in the road direction (imputation using the value at another position located in the opposite direction to the facility). In other words, the imputation unit 13 may determine whether to impute the traffic data in the direction of the traffic route or the direction of time according to the state information.

The imputation unit 13 outputs the imputed traffic data. For example, the imputation unit 13 outputs the imputed traffic data to another system, for example, a system that performs machine learning for generating a traffic condition prediction model. The imputation unit 13 may also output the imputed traffic data by a method other than that described above. Note that if the imputed traffic data includes missing data (NaN), for example, the imputed traffic data may not be used in the above-mentioned machine learning. In other words, only the imputed traffic data that does not include missing data may be used in the above-mentioned machine learning.

The time required to pass a certain section of a road can be calculated from traffic data obtained by a traffic counter or traffic data obtained by prediction based on data obtained by a traffic counter. When calculating the required time, the sum of tracked times is often used. Specifically, the arrival time at the next Y KP position (point Y) is calculated on the assumption that a vehicle travels from the starting point at the X KP position (point X) to point Y at the speed at point X. Next, the arrival time at the next Z KP position (point Z) is calculated on the assumption that a vehicle travels to point Z at the speed at point Y at the time of arrival at point Y. This calculation is repeated to calculate the required time from the starting point to the arrival point.

However, it is assumed that the actual speed changes gradually rather than changing abruptly at the position related to the traffic data (e.g., KP breakpoint such as points X and Y described above). Therefore, if the required time is calculated in a state where the speed changes at a position related to the traffic data, there is a concern that a temporary change in speed will continue to the next position, resulting in a value that is significantly different from the actual required time. Therefore, a virtual position may be placed between positions where data is actually measured by a traffic counter, the speed for the virtual position may be calculated (imputed) by the data imputation system 10 according to the present embodiment using contextual relationships as described above, and the required time may be calculated using this speed. In other words, the data imputation system 10 may correct the traffic data obtained by the traffic counter. As a result, it is possible to calculate a required time that is closer to the actual situation.

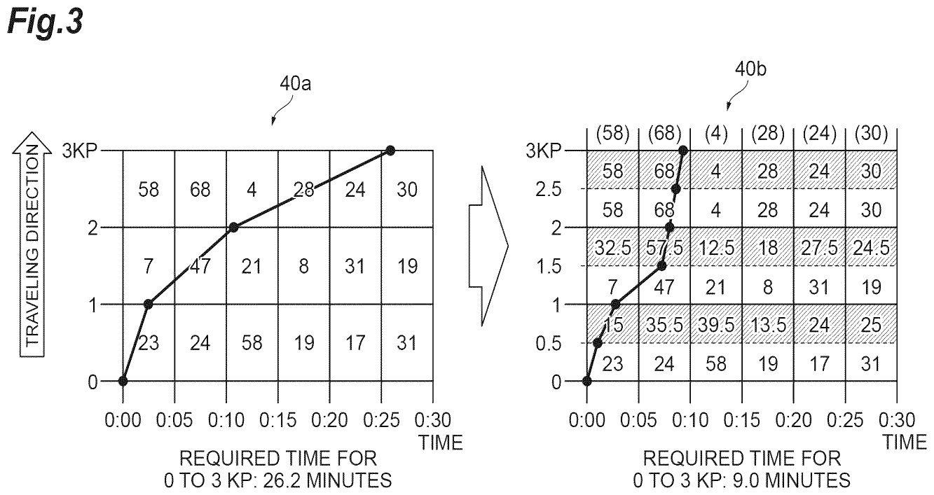

The calculation of the required time will be explained using the table of traffic data 40a in FIG. 3. In the example of the table of traffic data 40a in FIG. 3, the positions where data is measured by the traffic counter, that is, the positions related to the traffic data for calculating the required time, are set at every 1 KP. In the table of traffic data 40a, the vertical direction represents the distance in the direction of travel, and the horizontal direction represents the time (required time starting from 0:00). Also, the values in the table of traffic data 40a are the speed for each 5-minute time period and each position. For example, the speed at 0 KP from 0:00 to 0:05 is 23 [km/h].

As indicated by the line on the table of traffic data 40a, the vehicle starts from the 0 KP position at 0:00 and travels to the 1 KP position at 23 [km/h], which is the speed at the 0 KP position at that time. From the 1 KP position to the 2 KP position, the vehicle travels at 7 [km/h], which is the speed at the 1 KP position when 1 KP is reached. The required time from the 0 KP position to the 3 KP position is calculated as 26.2 minutes.

As mentioned above, the actual speed changes gradually rather than changing abruptly at the position related to the traffic data. However, if the intervals between the positions where the traffic counters measure data (positions where the traffic counters are installed) are wide, the impact of a slow speed at a certain position will be significant. In some cases, the required time of a vehicle that departs later may be shorter than that of a vehicle that departs earlier (the vehicle that departs later overtakes the vehicle that departs earlier), that is, a required time reversal phenomenon may occur.

Therefore, as illustrated in the table of traffic data 40b in FIG. 3, for example, a virtual position may be set, the value at the virtual position may be imputed by the data imputation system 10, and the required time may then be calculated. In the table of traffic data 40b in FIG. 3, the values illustrated in the hatched areas are the imputed values. In this example, the virtual position is the midpoint between the positions (1-KP interval positions) related to the original traffic data that are adjacent to each other. As illustrated in the table of traffic data 40b in FIG. 3, the virtual positions are the positions such as 0.5 KP, 1.5 KP, 2.5 KP. In other words, the virtual positions are positions such that the positions related to the traffic data after imputation are spaced at intervals of 500 m.

The imputation for the virtual position can be realized by the above-mentioned imputation. For example, the values at all times of the preset virtual position may be set as missing values (NaN) and imputed in the same manner as the above-mentioned imputation. For example, in this example, the imputed value of the virtual position is the average value of the values at the same time (time period) of the positions related to the original traffic data before and after the virtual position (e.g., the 0 KP and 1 KP positions for the 0.5 KP position). In the table of the traffic data 40b in FIG. 3, it is assumed that the speed at the 3 KP position is the same as the speed at the 2 KP position (the value in parentheses in the table of the traffic data 40b in FIG. 3). In the example illustrated in FIG. 3, the required time from the 0 KP position to the 3 KP position is calculated to be 9.0 minutes using the imputed traffic data (speed data).

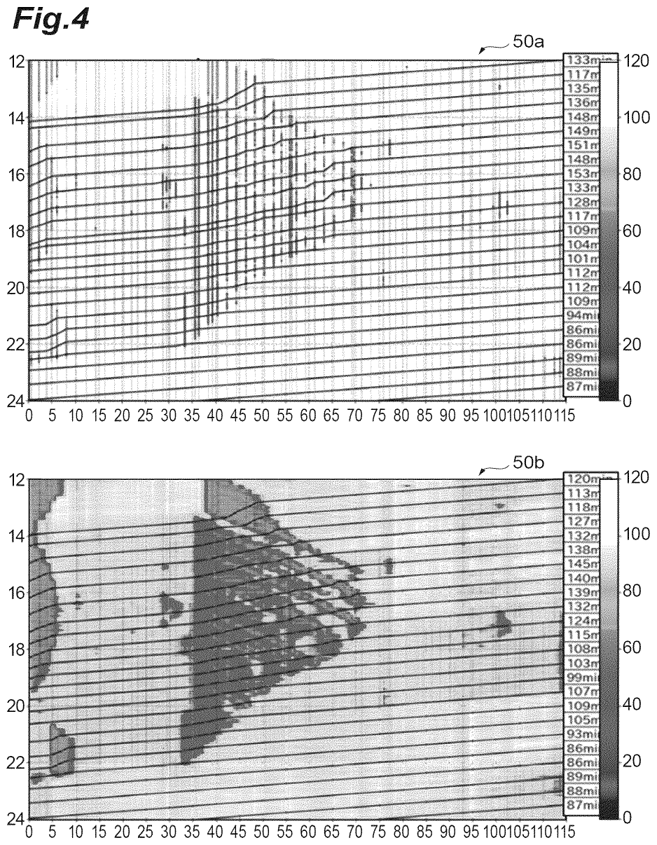

FIG. 4 illustrates an example of a heat map of the speed data 50a before imputation and a heat map of the speed data 50b after the above-mentioned imputation. The vertical and horizontal directions of the heat map of each speed data 50a and 50b are the same as the table of the traffic data 40a and 40b in FIG. 3. The lines in the heat map of each speed data 50a and 50b indicate the required time.

The above-mentioned influence when calculating the required time can be mitigated by using the traffic data imputed by the data imputation system 10. The data imputation system 10 may calculate the required time for a section on a road as described above from the traffic data imputed by the imputation unit 13. The functions of the data imputation system 10 according to the present embodiment have been described above.

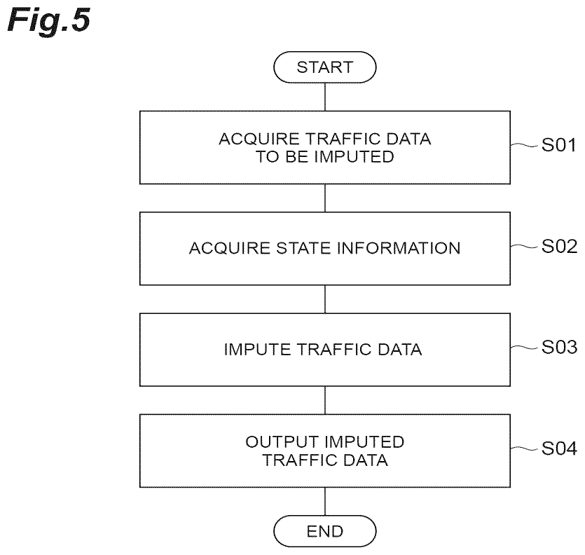

Next, the process executed by the data imputation system 10 according to the present embodiment (the operation method performed by the data imputation system 10) will be described using the flowchart of FIG. 5. In this process, imputation target acquisition unit 11 acquires the traffic data to be imputed (S01). The state information acquisition unit 12 acquires state information (S02). Note that the acquisition of traffic data by the imputation target acquisition unit 11 (S01) and the acquisition of state information by the state information acquisition unit 12 (S02) can be performed independently of each other, and therefore do not necessarily have to be performed in the above-mentioned order.

Then, the traffic data acquired by the imputation target acquisition unit 11 is imputed by the imputation unit 13 according to the state information acquired by the state information acquisition unit 12 (S03). Then, the imputed traffic data is output from the imputation unit 13 (S04). The process executed by the data imputation system 10 according to the present embodiment has been described above.

In the present embodiment, the traffic data is imputed according to the state information. Therefore, according to the present embodiment, the traffic data can be appropriately imputed according to the state of the traffic route. Simply imputing values without considering the state of the traffic route may reduce the usefulness of the traffic data, but by performing imputation taking the state of the traffic route into consideration as in the present embodiment, it is possible to prevent a reduction in the usefulness of the traffic data or improve the usefulness.

The present embodiment is an analysis technique for traffic data, which is one type of observation data obtained by observing real-world observation target phenomena. According to the present embodiment, for example, it is possible to provide traffic data, which is a type of big data, and has been appropriately imputed. Specifically, as described above, when data is missing due to a malfunction during data measurement, it is possible to generate traffic data in which missing parts are appropriately imputed. Alternatively, when there is a possibility of the required time reversal phenomenon due to the data measurement intervals, the problem can be avoided by using the imputed traffic data.

As in the present embodiment, the state information may be information indicating the position of a facility (e.g., an interchange, junction, parking area, or service area, as described above) that exists on the traffic route. According to this configuration, it is possible to appropriately impute the traffic data, taking into account the position of a facility that may affect the traffic data. However, as described above, the state information may be information other than the information indicating the position of the facility, as long as the information indicates the state of the traffic route that may affect the traffic data.

As in the present embodiment, the imputation unit 13 may determine, according to the state information, which direction data of the traffic route, based on the position of the imputation target in the traffic data, will be used for imputation. Also, as in the present embodiment, the traffic data is traffic data for a plurality of times, and the imputation unit 13 may determine, according to the state information, whether to perform imputation of the traffic data in the traffic route direction or in the time direction. With these configurations, the traffic data can be imputed appropriately and reliably. However, the imputation of the traffic data by the imputation unit 13 may be performed by a method other than that described above as long as it is performed according to the state information. Also, the traffic data does not necessarily have to be data for each of a plurality of times, and may be data related to traffic for each of a plurality of positions on the traffic route.

As in the present embodiment, the traffic data may be traffic volume or speed data for each of a plurality of positions on the traffic route. With this configuration, the traffic data on the traffic volume or speed can be imputed appropriately. However, the traffic data does not necessarily have to be the above, and may be data related to traffic.

In the block diagrams with reference to which the embodiment has been described, blocks of functional units are illustrated. Such functional blocks (component units) are realized by an arbitrary combination of at least one of hardware and software. In addition, a method for realizing each functional block is not particularly limited. In other words, each functional block may be realized by using one apparatus that is combined physically or logically or using a plurality of apparatuses by directly or indirectly (e.g., using a wire or wirelessly) connecting two or more apparatuses separated physically or logically. A functional block may be realized by one apparatus or a plurality of apparatuses described above and software in combination.

The functions include determining, deciding, determination, calculating, computing, processing, deriving, investigating, searching, ascertaining, receiving, transmitting, outputting, accessing, resolving, selecting, choosing, establishing, comparing, supposing, expecting, considering, broadcasting, notifying, communicating, forwarding, configuring, reconfiguring, allocating or mapping, and assigning, but are not limited thereto. For example, a functional block (constituent unit) enabling transmission to function is referred to as a transmitting unit or a transmitter. In either case, as described above, realization methods are not particularly limited.

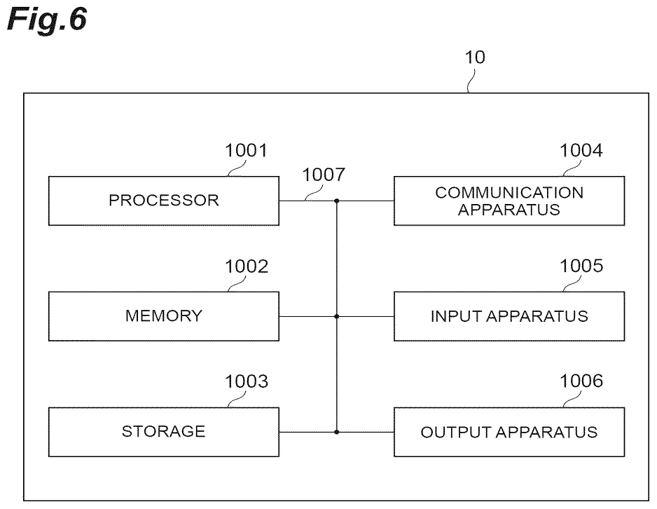

For example, the data imputation system 10 according to an embodiment of the present disclosure may function as a computer that performs information processing of the present disclosure. FIG. 6 is a diagram illustrating an example of a hardware configuration of the data imputation system 10 according to an embodiment of the present disclosure. The above-described data imputation system 10 may be physically configured as a computer apparatus including a processor 1001, a memory 1002, a storage 1003, a communication apparatus 1004, an input apparatus 1005, an output apparatus 1006, a bus 1007, and the like.

In addition, in the following description, a term “apparatus” may be rephrased as a circuit, a device, a unit, or the like. The hardware configuration of the data imputation system 10 may be configured to include one or a plurality of apparatuses illustrated in the drawing and may be configured without including some of these apparatuses.

The processor 1001 performs an arithmetic operation by reading predetermined software (a program) onto hardware such as the processor 1001 or the memory 1002, and thus each function of the data imputation system 10 is realized by controlling communication in the communication apparatus 1004 or controlling at least one of reading-out and writing of data in the memory 1002 and the storage 1003.

The processor 1001, for example, controls the entire computer by operating an operating system. The processor 1001 may be configured as a central processing unit (CPU) including an interface with peripherals, a controller, an arithmetic operation unit, and a register. For example, each function of the data imputation system 10 described above may be realized by the processor 1001.

The processor 1001 reads a program (a program code), a software module, data, or the like from the storage 1003 and/or the communication apparatus 1004 to the memory 1002 and performs various processes in accordance therewith. As the program, a program that causes a computer to perform at least some of the operations described above in the embodiment is used. For example, each function of the data imputation system 10 may be realized by a control program that is stored in the memory 1002 and operated by the processor 1001. The various processes described above are described as being performed by a single processor 1001, but they may be simultaneously or sequentially performed by two or more processors 1001. The processor 1001 may be mounted as one or more chips. The program may be transmitted from a network via an electrical communication line.

The memory 1002 is a computer-readable recording medium and may be constituted by, for example, at least one of a read only memory (ROM), an erasable programmable ROM (EPROM), an electrically erasable programmable ROM (EEPROM), and a random access memory (RAM). The memory 1002 may be referred to as a register, a cache, a main memory (main storage apparatus), or the like. The memory 1002 can store an executable program (program code), a software module, or the like that can be executed to perform information processing according to an embodiment of the present disclosure.

The storage 1003 is a computer-readable recording medium and may be constituted by, for example, at least one of an optical disc such as a compact disc ROM (CD-ROM), a hard disk drive, a flexible disk, a magneto-optical disc (e.g., a compact disc, a digital versatile disc, or a Blu-ray (registered trademark) disc), a smart card, a flash memory (e.g., a card, a stick, or a key drive), a floppy (registered trademark) disk, and a magnetic strip. The storage 1003 may be referred to as an auxiliary storage apparatus. The storage medium included in the data imputation system 10, for example, may be a database including at least one of the memory 1002 and a storage 1003, a server, or any other appropriate medium.

The communication apparatus 1004 is hardware (a transmitting and receiving device) that performs communication between computers via a wired and/or wireless network and is also referred to as, for example, a network device, a network controller, a network card, or a communication module.

The input apparatus 1005 is an input device (e.g., a keyboard, a mouse, a microphone, a switch, buttons, a sensor, or the like) that accepts an input from the outside. The output apparatus 1006 is an output device (e.g., a display, a speaker, an LED lamp, or the like) that performs output to the outside. In addition, the input apparatus 1005 and the output apparatus 1006 may have an integrated configuration (e.g., a touch panel).

The apparatuses such as the processor 1001 and the memory 1002 are connected to each other via the bus 1007 for transmission of information. The bus 1007 may be configured using a single bus, or may be configured using different buses between apparatuses.

In addition, the data processing system 10 may be configured to include hardware such as a microprocessor, a digital signal processor (DSP), an application specific integrated circuit (ASIC), a programmable logic device (PLD), or a field programmable gate array (FPGA), or some or all of the respective functional blocks may be realized by the hardware. For example, the processor 1001 may be mounted using at least one of these types of hardware.

The order of processes, the sequences, the flowcharts, and the like of the aspects/embodiments described above in the present disclosure may be changed unless conflictions arise. For example, in the methods described in the present disclosure, various steps are described as elements of an exemplary order, but the methods are not limited to the described order.

Information or the like which is input or output may be stored in a specific place (e.g., a memory) or may be managed using a management table. Information or the like which is input or output may be overwritten, updated, or added. The output information and the like may be deleted. The input information and the like may be transmitted to another apparatus.

Determination may be performed using a value (0 or 1) which is expressed by one bit, may be performed using a Boolean value (true or false), or may be performed by comparison of numerical values (e.g., comparison thereof with a predetermined value).

The aspects/embodiments described in this specification may be used alone, may be used in combination, or may be switched during implementation thereof. In addition, a notification of predetermined information (e.g., a notification of being X) is not limited to be performed explicitly and may be performed implicitly (e.g., a notification of the predetermined information is not performed).

As above, while the present disclosure has been described in detail, it is apparent to a person skilled in the art that the present disclosure is not limited to the embodiments described in the present disclosure. The present disclosure may be modified or changed without departing from the concept and the scope of the present disclosure set according to the claims. Thus, the description presented in the present disclosure is for the purpose of exemplary description and does not have any limited meaning for the present disclosure.

It is apparent that software, regardless whether it is called software, firmware, middleware, a microcode, a hardware description language, or any other name, be widely interpreted to mean a command, a command set, a code, a code segment, a program code, a program, a subprogram, a software module, an application, a software application, a software package, a routine, a subroutine, an object, an executable file, an execution thread, an order, a function, and the like.

In addition, software, a command, information, and the like may be transmitted and received through a transmission medium. For example, when software is transmitted from a website, a server, or another remote source using at least one of wired technology (such as a coaxial cable, an optical fiber cable, a twisted-pair wire, or a digital subscriber line (DSL)) and wireless technology (such as infrared rays or microwaves), at least one of the wired technology and the wireless technology are included in the definition of a transmission medium.

The terms “system” and “network” used in the present disclosure are used interchangeably.

In addition, information, parameters, and the like described in the present disclosure may be expressed using absolute values, may be expressed using values relative to a predetermined value, or may be expressed using other corresponding information.

Terms such as “determining” used in the present disclosure may include various operations of various types. The “determining”, for example, may include a case in which judging, calculating, computing, processing, deriving, investigating, looking up, search, and inquiry (e.g., looking up a table, a database, or any other data structure), or ascertaining is regarded as “determining”. In addition, “determining” may include a case in which receiving (e.g., receiving information), transmitting (e.g., transmitting information), input, output, or accessing (e.g., accessing data in a memory) is regarded as “determining”. Furthermore, “determining” may include a case in which resolving, selecting, choosing, establishing, comparing, or the like is regarded as “determining”. In other words, “determining” includes a case in which a certain operation is regarded as “determining”. In addition, “determining” may be rephrased with “assuming”, “expecting”, “considering”, and the like.

The terms “connected” and “coupled” and every modification thereof refer to direct or indirect connection or coupling between two or more elements and can include that one or more intermediate element is present between two elements “connected” or “coupled” to each other. The coupling or connecting of elements may be physical, may be logical, or may be a combination thereof. For example, “connection” may be read as “access”. When used in the present disclosure, two elements may be considered as being mutually “connected” or “coupled” by using one or more wires and at least one of a cable and a print electric connection and, as several non-limiting and non-comprehensive examples, by using electromagnetic energy having wavelengths in a radio frequency region, a microwave region, and a light (both visible light and non-visible light) region.

The expression “based on” used in the present disclosure does not mean “based on only” unless otherwise described. In other words, description of “based on” means both “based on only” and “based on at least”.

Any referring to elements, for which names of “first”, “second”, and the like are used, used in the present disclosure does not generally limit the amount or the sequence of such elements. The terms can be conveniently used to distinguish two or more elements in the present disclosure. Accordingly, referring to the first and second elements does not mean that only the two elements are employed therein or the first element precedes the second element in a certain form.

When the terms “include” and “including” and modifications thereof are used in the present disclosure, the terms are intended to have a comprehensive meaning similar to the term “comprising”. The term “or” used in the present disclosure is not intended to mean an exclusive logical sum.

In the present disclosure, for example, when an article such as a, an, or the in English is added in translation, the present disclosure may include a case in which a noun subsequent to the article is of a plural type.

In the present disclosure, a term “A and B are different” may mean that “A and B are different from each other”. The expression may mean that “A and B are different from C”. Expressions such as “separated” and “coupled” may be construed in the same way as “different”.

The data imputation system disclosed herein has the following configuration.
[1] A data imputation system including:
   an imputation target acquisition unit that acquires traffic data that is data related to traffic for each of a plurality of positions on a traffic route and is also an imputation target;
   a state information acquisition unit that acquires state information indicating a state of the traffic route; and
   an imputation unit that imputes the traffic data acquired by the imputation target acquisition unit according to the state information acquired by the state information acquisition unit.
[2] The data imputation system according to [1], in which the state information acquisition unit acquires information indicating a position of a facility existing on the traffic route as the state information.
[3] The data imputation system according to [1] or [2], in which the imputation unit determines which direction data of the traffic route, based on the position of the imputation target in the traffic data, will be used for imputation according to the state information.
[4] The data imputation system according to any one of [1] to [3], in which the imputation target acquisition unit acquires the traffic data for each of a plurality of times, and the imputation unit determines whether to perform imputation of the traffic data in a traffic route direction or in a time direction according to the state information.
[5] The data imputation system according to any one of [1] to [4], in which the imputation target acquisition unit acquires the traffic data, which is data on traffic volume or speed for each of a plurality of positions on a traffic route.

### REFERENCE SIGNS LIST

10 Data imputation system, 11 Imputation target acquisition unit, 12 State information acquisition unit, 13 Imputation unit, 1001 Processor, 1002 Memory, 1003 Storage, 1004 Communication apparatus, 1005 Input apparatus, 1006 Output apparatus, 1007 Bus

1. A data imputation system comprising circuitry configured to:
acquire traffic data that is data related to traffic for each of a plurality of positions on a traffic route and is also an imputation target;
acquire state information indicating a state of the traffic route; and
impute the acquired traffic data according to the acquired state information.

2. The data imputation system according to claim 1, wherein the circuitry acquires information indicating a position of a facility existing on the traffic route as the state information.

3. The data imputation system according to claim 1, wherein the circuitry determines which direction data of the traffic route, based on the position of the imputation target in the traffic data, will be used for imputation according to the state information.

4. The data imputation system according to claim 1, wherein the circuitry acquires the traffic data for each of a plurality of times, and
determines whether to perform imputation of the traffic data in a traffic route direction or in a time direction according to the state information.

5. The data imputation system according to claim 1, wherein the circuitry acquires the traffic data, which is data on traffic volume or speed for each of a plurality of positions on a traffic route.
